(19) United States
(12) Patent Application Publication
(10) Pub. No.: US 2009/0216651 A1
(43) Pub. Date: Aug. 27, 2009

(54) Dispensing valuable media

(75) Inventors: Gameelah Ghafoor, Broughty Ferry (GB); Richard D. Lawson, Broughty Ferry (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/070,979

(22) Filed: Feb. 22, 2008

(51) Int. Cl. G06Q 30/00; G06Q 20/00

(52) U.S. Cl. 705/17; 705/44

(57) ABSTRACT

A method of dispensing valuable media from a self-service terminal. The method comprises: receiving a request from a customer at the self-service terminal to access an account held with a payment service provider. The terminal then forwards the request to the payment service provider and provides the payment service provider with authentication details from the customer at the self-service terminal. The terminal then receives a request to dispense valuable media from the payment service provider, and dispenses valuable media to the customer in response to the received request. The method may also involve charging the payment service provider an amount at least equal in value to the valuable media dispensed.

### FIELD OF INVENTION

The present invention relates generally to dispensing valuable media.

### BACKGROUND OF INVENTION

Online payment service providers (such as Paypal (trademark)) provide mechanisms for their customers to pay for goods or services over the Internet without having to divulge their credit or debit card details to the vendor of those goods or services.

To receive cash (physical currency) from a payment service provider, a vendor (who is also a customer of the payment service provider) first has to transfer funds from their account with the payment service provider to their bank account, then they can withdraw cash corresponding to the transferred amount from their bank account.

It would be an advantage if customers of a payment service provider could receive funds from the payment service provider without first having to transfer the funds to a bank account. It would also be an advantage if customers of a payment service provider could receive funds from the payment service provider without requiring a bank account.

### SUMMARY OF INVENTION

Accordingly, the invention generally provides methods, systems, apparatus, and software for dispensing valuable media to a customer at a self-service terminal.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a method of dispensing valuable media from a self-service terminal, the method comprising: receiving a request from a customer at the self-service terminal to access an account held with a payment service provider; forwarding the request to the payment service provider; providing the payment service provider with authentication details from the customer at the self-service terminal; receiving a request to dispense valuable media from the payment service provider; dispensing valuable media to the customer in response to the received request; and charging the payment service provider an amount at least equal in value to the valuable media dispensed.

As used herein, a payment service provider is not a bank, building society, savings provider, credit card issuer, charge card issuer, or the like. A payment service provider is an entity that holds funds for a customer until such funds are transferred to a bank or used for a purchase.

The step of receiving a request from a customer at the self-service terminal to access an account held with a payment service provider may be implemented by displaying a screen on the self-service terminal having a menu option for accessing an account held with the payment service provider.

The step of forwarding the request to the payment service provider may be implemented by forwarding the request directly to the payment service provider or by forwarding the request via a financial host that authorizes transactions for that self-service terminal.

The step of providing the payment service provider with authentication details from the customer at the self-service terminal may include providing information read from a card or other token presented by the customer at the self-service terminal. Alternatively, the step of providing the payment service provider with authentication details from the customer at the self-service terminal may include forwarding details entered by the customer in response to a request from the payment service provider, such details may include a passcode provided to the customer by the payment service provider prior to the customer using the self-service terminal. The step of providing the payment service provider with authentication details from the customer may include providing information derived from a biometric reading from the customer, for example, a customer's iris pattern, fingerprint, vein pattern, or the like.

The step of receiving a request to dispense valuable media from the payment service provider may include receiving a request in a predefined format. The request to dispense valuable media from the payment service provider may be received directly from the payment service provider, or via a financial host.

The method may include the further step of charging an additional fee for executing the transaction.

Communications between the payment service provider and the self-service terminal may be encrypted and/or protected by other conventional security mechanisms, such as using a hash value.

According to a second aspect there is provided a computer program for a self-service terminal, the computer program being operable, when executed on a self-service terminal, to implement the method of the first aspect.

According to a third aspect there is provided a system for dispensing valuable media from a self-service terminal, the system comprising: a payment service provider server, and a self-service terminal for receiving a request from a customer to access an account held with a payment service provider, the self-service terminal being operable to dispense valuable media to the customer in response to the received request; and charging the payment service provider an amount at least equal in value to the valuable media dispensed.

According to a fourth aspect there is provided a method of dispensing valuable media from a self-service terminal, the method comprising: authenticating a customer at the self-service terminal; receiving a transaction request from the customer for conducting a transaction relating to an account held by the customer with a payment service provider; receiving from the customer a customer access code and a transaction identifier that corresponds to the transaction request; transmitting the transaction identifier corresponding to the transaction request to the payment service provider; receiving transaction details from the payment service provider, wherein the transaction details include a transaction access code and a correspondent transaction value; comparing the received customer access code with the received transaction code to ascertain if there is a match; and in the event of a match, dispensing to the customer an amount of valuable media corresponding to the transaction value.

The method may further comprise the step of receiving confirmation from the customer to proceed with the transaction prior to dispensing to the customer the valuable media.

Transmitting the transaction identifier may include sending the transaction value to the payment service provider for authorization and accessing the account held by the customer.

According to a fifth aspect there is provided a method of authenticating dispensing of valuable media to a customer, the method comprising: receiving a customer identifier from a self service terminal; accessing a database storing a plurality of transaction entries, each transaction entry comprising a pending transaction value and an associated transaction access code; retrieving a transaction entry for the customer using the customer identifier; transmitting the retrieved transaction entry to the self-service terminal; receiving a response from the self-service terminal indicating that the pending transaction value has been dispensed to the customer; and updating the transaction entry in the database for that customer to indicate that the transaction has been fulfilled.

The method may comprise the further step of electronically debiting the transaction value from an account held by the customer.

The method may comprise the further step of providing a confirmation to the customer via a different communications channel after updating the transaction entry in the database for that customer.

The step of providing a confirmation to the customer via a different communications channel may include sending an electronic mail message to an electronic mail account of the customer.

According to a sixth aspect there is provided a method of dispensing valuable media to a customer, the method comprising: transmitting a transaction request to a payment service provider; receiving an access code corresponding to a transaction value from the payment service provider; providing the customer with an option to withdraw valuable media up to the transaction value; and dispensing an amount of valuable media in response to selection by the customer of the option to withdraw valuable media.

By virtue of this aspect a customer can withdraw physical cash from his/her payment service provider account via a self-service terminal, without having to transfer the funds to a bank account.

These and other aspects will be apparent from the following specific description, given by way of example, with reference to the accompanying drawings.

### BRIEF DESCRIPTION OF THE DRAWINGS

FIG. 1 is a block diagram of a transaction system for dispensing valuable media from a self service terminal in accordance with an embodiment of the present invention;

FIG. 2 is a flowchart illustrating steps performed by the system of FIG. 1; and

FIG. 3 is a block diagram of an entry in a part (the payment provider server) of the system of FIG. 1;

### DETAILED DESCRIPTION

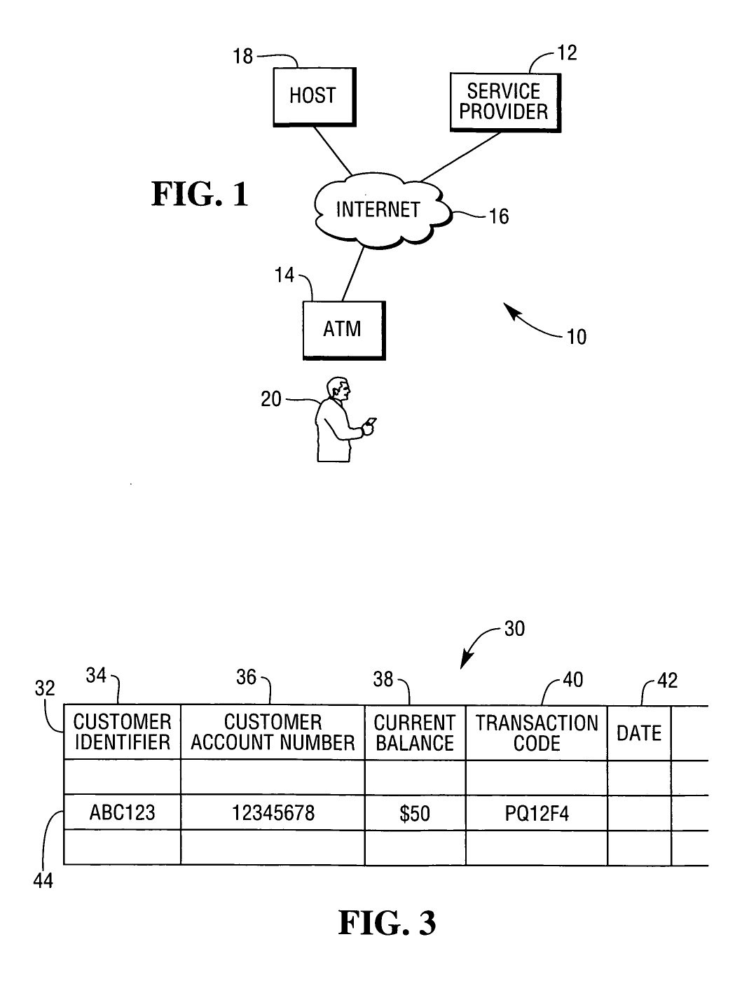

Reference is made to FIG. 1 which is a block diagram of a transaction system 10 for dispensing valuable media (in the form of banknotes) from a self-service terminal in accordance with an embodiment of the present invention.

The system 10 comprises a server 12 operated by a payment service provider (such as Paypal (trade mark)) coupled to a self service terminal 14 (in the form of an ATM) by a communication network 16 (such as the Internet). The ATM 14 is also connected to a financial institution host 18 for authorizing ATM transactions. A customer 20 of the ATM 14 is also illustrated in FIG. 1.

The payment service provider server 12 implements an e-commerce business. The payment service provider server 12 receives payments sent via the Internet 16, and transfers funds to customer's bank accounts via the Internet 16.

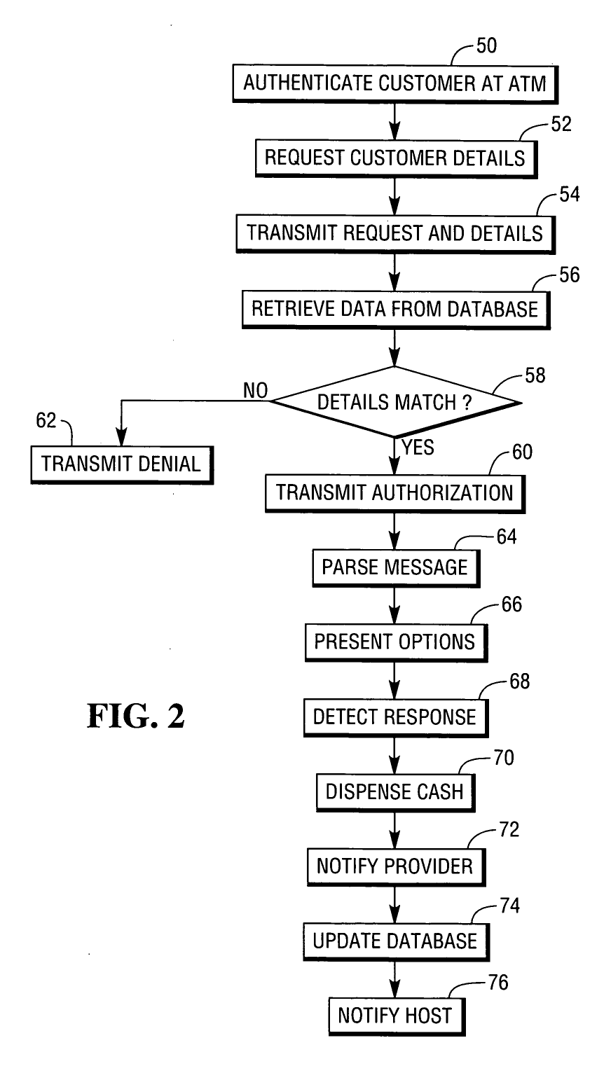

Reference will now also be made to FIG. 2, which is a flowchart illustrating steps performed by the system of FIG. 1. Reference will also be made to FIG. 3, which is a block diagram of an entry in the payment provider server 12. In this example, the customer 20 has an account with the bank that owns and operates the ATM 14.

Prior to using the ATM 14, the customer 20 sold some goods over the Internet, and the purchaser paid fifty dollars ($50) to the customer's account with the payment service provider. The payment provider server 12 includes a database 30 (best seen in FIG. 3) that records details of this transaction. The database 30 is illustrated as having a header row 32 indicating the fields available for each entry. These fields include: a customer identifier field 34, a customer account number field 34, a current balance field 38, a transaction code field 40, a date of last transaction field 42, amongst other fields.

Each entry in the database 30 relates to a customer account. For simplicity, only one customer entry 44 is illustrated in FIG. 3.

The customer 20 can access at least some of the information contained in this database 30 via a Web site operated by the payment service provider 12. The customer 20 can request the payment service provider 12 to create and send to the customer 20 a transaction code (which is then stored in transaction code field 40) to allow the customer to withdraw cash at an ATM such as ATM 14.

The payment service provider server 12 may send this transaction code (in this example it is “PQ12F4”) to the customer via any convenient channel. For example, the customer 20 may have registered a cellular telephone number with the payment service provider server 12 (stored in another field of the database 30) to which the transaction code may be sent via a text message. As another example, the customer 20 may have registered an electronic mail (email) address with the payment service provider server 12 (stored in another field of the database 30) to which the transaction code may be sent.

Once the customer 20 has the transaction code, the customer 20 can approach the ATM 14. Initially, the customer 20 inserts an ATM card into the ATM 14 and then enters his/her PIN. The ATM 14 then uses the bank host 18 to authenticate the customer 20 (step 50). The bank host 18 then instructs the ATM 14 to display a screen including an option for accessing an account the customer has with a payment provider.

The customer 20 then selects the option for accessing the payment provider. The ATM 14 detects this selection and requests the customer 20 to enter his/her customer identifier (for the service provider) and transaction code (previously generated and issued by the service provider) by displaying a keyboard and instructions on how to enter letters and numbers using the ATM's keypad and/or FDKs (step 52).

The ATM 14 then transmits a direct request to the payment provider (step 54) over the Internet 16. This request includes the customer identifier and transaction code. In this example, the customer 20 entered “ABC123” as the customer identifier, and “PQ12F4” as the transaction code.

The payment provider server 12 receives the request (including the customer identifier and transaction code) and accesses the database 30 (which stores transaction details for customers having an account with the payment provider) to retrieve the entry for the received customer identifier (step 56).

The payment provider server 12 then ascertains if the entered customer identifier and transaction code match the contents of an entry in the database 30 (step 58).

In this example, the entered customer identifier “ABC123” and transaction code “PQ12F4” match the contents of the corresponding fields 34,40 of entry 42, so the payment service provider server 12 transmits an authorization message (step 60) authorizing the ATM 14 to dispense up to $50 (the contents of the current balance field 38) to the customer 20.

If the entered customer identifier and transaction code do not match the contents of an entry in the database 30 then the service provider server 12 transmits a denial message informing the ATM 14 that the request is not valid (step 62). The ATM 14 may record the customer's details, such as account number from the ATM card, in case the card is stolen or in case of some other irregularity.

When the ATM 14 receives the authorization message sent in step 60, then the ATM 14 parses the message to ascertain how much cash may be dispensed. In this example, up to $50 may be dispensed (step 64).

The ATM then displays a screen inviting the customer 20 to indicate how much cash he/she wishes to withdraw, up to a maximum of $50 (step 66).

The customer 20 then types in a transaction amount (in this example, $50), which is detected by the ATM 14 (step 68), and the ATM 14 then dispenses this amount of cash to the customer (that is, $50) (step 70).

The customer 20 then retrieves his/her cash and ATM card from the ATM 14. The ATM 14 then notifies the payment service provider server 12 that the transaction has been fulfilled for the full amount (that is, $50) (step 72).

The payment service provider 12 then updates its database 30 to reflect this transaction (step 74) and the ATM 14 then notifies the host 18 of this transaction (step 76) so that the host 18 can charge the payment service provider for this transaction. The host 18 may also charge the payment service provider a transaction fee in addition to charging $50 for the amount of money dispensed.

Various modifications may be made to the above described embodiment within the scope of the present invention. For example, in the above embodiment, the customer used an ATM card to authenticate himself/herself at the ATM, in other embodiments, the ATM may use a biometric reader to authenticate the customer, or some other credentials may be used, such as a social security number, a passport number, a driver's license number, a telephone number, a national insurance number, a bank account number, or the like.

In the above embodiment, the ATM communicated directly with the payment service provider server; in other embodiments, the ATM may communicate with the payment service provider server via the financial institution host 18.

In the above embodiment, the only some of the details stored in the database 30 are shown. In other embodiments, the database 30 may store additional details, such as an expiry time and/or date for the transaction code, a list of all transactions, or all transactions in a predefined period, for example, the last thirty days, customer contact information such as a mailing address, telephone number, email address, and the like.

In other embodiments, the payment provider server 12 may send a list of all pending transactions to the ATM 14 for display to the customer 20.

The payment service provider may levy its own charge on the customer for using an ATM to dispense cash.

The transaction code may be a numeric code, an alphanumeric code, or any other convenient code or symbology. In some embodiments, a code may comprise several items of the customer's information including the customer's name, address, telephone number, social security number, account number, or the like.

In other embodiments, the customer 20 may be permitted to create a transaction code, thereby ensuring that the code may be memorable for the customer.

In other embodiments, the customer may use a cash deposit ATM to make payments to his/her account with the payment service provider. This can be achieved by the customer providing the customer identifier and the amount of money. The ATM can then verify that the correct amount of money has been deposited, provide a unique transaction code to the customer as a receipt, and then inform the payment service provider server 12 about the customer identifier and the amount of cash deposited. The payment service provider server 12 can then update the customer's entry in the database 30 to reflect the cash added by the customer.

1. A method of dispensing valuable media from an Automated Teller Machine, ATM, the method comprising:
a) receiving a request from a customer at the ATM to access an account which is held with a payment service provider for the customer's benefit, wherein
i) said payment service provider is not a bank or credit card issuer,
ii) the request includes a transaction code which the customer previously received from the payment service provider, and
iii) the account at the payment service provider contains payments received from purchasers in sales previously made by the customer to the third parties;
b) forwarding the request, including the transaction code, to the payment service provider;
c) providing the payment service provider with authentication details about the customer;
d) receiving a request from the customer at the ATM to dispense valuable media
e) dispensing valuable media to the customer in response to the received request; and
f) charging the payment service provider an amount at least equal in value to the valuable media dispensed.

2. A method according to claim 1, wherein the step of receiving a request from a customer is accompanied by display of a menu option for accessing an account held with the payment service provider.

3. A method according to claim 1, wherein the step of forwarding the request to the payment service provider is implemented by forwarding the request via a financial host that authorizes transactions for that ATM.

4.-10. (canceled)

11. A method according to claim 1, wherein the
1) the payment service provider determines whether the transaction code received from the customer matches a stored transaction code for the customer, and
2) the valuable media is dispensed if the match is found.

12. A method of operating an Automated Teller Machine, ATM, comprising:
a) authenticating a customer who has previously received a transaction code from a payment service provider which provider holds an account containing proceeds of sales made by the customer;
b) presenting an option to the customer which allows the customer to contact the payment service provider;
c) at the ATM, receiving a request for cash from the customer;
d) at the ATM, receiving the transaction code from the customer;
e) transmitting the transaction code from the ATM to the payment service provider;
f) if the payment service provider approves the request for cash, dispensing cash to the customer;
g) if the payment service provider does not approve the request for cash, dispensing no cash to the customer.

13. A method according to claim 12, wherein the payment service provider is not a bank nor a credit card company.

14. A method according to claim 12, wherein the payment service provider compares the transaction code received from the customer with a stored transaction code in the customer's records.

15. A method of operating an Automated Teller Machine, ATM, which dispenses cash to customers, comprising:
a) maintaining a first account with a bank for a customer who
i) makes sales on the Internet, proceeds of which are held in a second account maintained by a payment service provider and
ii) is in possession of a transaction code given to him by the payment service provider;
b) when the customer wishes to obtain money from the second account,
i) authenticating the customer and receiving the transaction code from the customer at the ATM;
ii) submitting the transaction code to the payment service provider for approval;
iii) if the payment service provider gives approval, dispensing cash from the ATM and issuing a charge to the second account; and
iv) if the payment service provider gives no approval, dispensing no cash from the ATM.

16. A method according to claim 15, wherein the payment service provider is not a bank or credit card company.

17. A method according to claim 16, wherein the ATM displays an option allowing the customer to retrieve money from the second account.

18. A method according to claim 12, in which proceeds in the account were received by the payment service provider from purchasers involved in the sales.

19. A method according to claim 15, in which proceeds in the second account were received by the payment service provider from purchasers involved in the sales.
